(19) United States
(12) Patent Application Publication
(10) Pub. No.: US 2017/0364131 A1
(43) Pub. Date: Dec. 21, 2017

(54) SYSTEM AND METHOD TO ENHANCE A FEEDBACK LOOP OF A POWER CONVERTER

(71) Applicant: TELEFONAKTIEBOLAGET LM ERICSSON (PUBL), Stockholm (SE)

(72) Inventors: Magnus MELLTEG, Kalmar (SE); Magnus KARLSSON, Oskarshamn (SE)

(21) Appl. No.: 15/187,277

(22) Filed: Jun. 20, 2016

(51) Int. Cl. G06F 1/26

(52) U.S. Cl. CPC G06F 1/26

(57) ABSTRACT

A system and method of determining a value of a feedback parameter of a feedback loop of a power converter. In one embodiment, the method includes shifting an open-loop performance characteristic and a closed-loop performance characteristic of the feedback loop so that values thereof are greater than or equal to respective constants. The method also includes normalizing the open-loop performance characteristic and the closed-loop performance characteristic to a common scale to provide a normalized open-loop performance characteristic and a normalized closed-loop performance characteristic. The method also includes combining the normalized open-loop performance characteristic with the normalized closed-loop performance characteristic to provide a combined normalized performance characteristic. The method also includes finding a value of the feedback parameter that produces an extremum of the combined normalized performance characteristic.

### TECHNICAL FIELD

The present invention is directed, in general, to the field of power electronics and, more specifically, to a system and method to enhance a feedback loop of a power converter.

### BACKGROUND

A switched-mode power converter is a type of power converter having a diverse range of applications by virtue of its small size, weight and high efficiency. For example, switched-mode power converters are widely used in personal computers and portable electronic devices such as cellphones. A switching device (e.g., a metal-oxide semiconductor field-effect transistor (“MOSFET”)) of a power train of the switched-mode power converter is controlled to convert an input voltage to a desired output voltage. A frequency (also referred to as a “switching frequency”) and duty cycle of the switching device is adjusted using a feedback signal to convert the input voltage to the desired output voltage.

A feedback loop (also referred to as a “compensation loop” or “feedback circuit”) of the power converter that provides the feedback signal may be monitored and adjusted to enhance the regulation of the output characteristic such as the output voltage. The feedback loop is typically includes a controller that regulates the switching frequency or the duty cycle to regulate the output voltage in accordance with a control law defined by one or more feedback parameters. For example, the controller may include a proportional-integral-derivative (“PID”) regulator that regulates the duty cycle (or the switching frequency) of the switching device(s) to keep the output voltage constant in accordance with the feedback loop that is characterized by the values of the P, I and D parameters set in the PID regulator.

Optimizing a feedback loop for a power converter has been traditionally performed in the analog domain using open-loop Bode plots, generally with only two performance characteristics. That being said, in most cases only a phase margin was of interest since the gain margin was often fulfilled without special attention. This conventional optimization is more straightforward since only one performance characteristic (e.g., the phase margin) is specifically addressed, while the second performance characteristic (e.g., the gain margin) is only checked thereafter.

With the advent of digital controllers (e.g., time-discrete controllers), a Nyquist sampling theorem comes into play and the fact that the spectrum becomes periodic with the sampling frequency. The assessment of closed-loop performance characteristics now arises. A performance check for a peak gain of the feedback loop may be obtained. As an example, if the peak gain is too high and the damping of the system is low, oscillatory behavior during transients may occur. Due to the periodic spectrum, if the gain at the Nyquist frequency is too high, the feedback loop may experience undesirable behavior.

Despite continued efforts to improve and simplify design techniques to produce a closed-loop feedback arrangement operable with digital elements, a system and method are needed to overcome the remaining substantial challenges to select feedback parameters, particularly feedback parameters that can be used in diverse and varying customer applications that may be encountered outside a laboratory or manufacturing environment. What is needed in the art, therefore, is a system and method that can further improve a process for selecting feedback parameters for a feedback loop of a power converter.

### SUMMARY

These and other problems are generally solved or circumvented, and technical advantages are generally achieved, by advantageous embodiments of the present invention for a system and method of determining a value of a feedback parameter of a feedback loop of a power converter. In one embodiment, the method includes shifting an open-loop performance characteristic and a closed-loop performance characteristic of the feedback loop so that values thereof are greater than or equal to respective constants. The method also includes normalizing the open-loop performance characteristic and the closed-loop performance characteristic to a common scale to provide a normalized open-loop performance characteristic and a normalized closed-loop performance characteristic. The method also includes combining the normalized open-loop performance characteristic with the normalized closed-loop performance characteristic to provide a combined normalized performance characteristic. The method also includes finding a value of the feedback parameter that produces an extremum of the combined normalized performance characteristic.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a power converter;

FIG. 2 illustrates a schematic diagram of another embodiment of a power converter;

FIGS. 3 to 10 illustrate graphical representations of embodiments of open- and closed-loop performance characteristics for a feedback parameter;

FIGS. 11 to 13 illustrate two dimensional graphical representations of an embodiment of open- and closed-loop performance characteristics for a feedback parameter;

FIGS. 14 to 18 illustrated three dimensional graphical representations of an embodiment of open- and closed-loop performance characteristics for a feedback parameter;

FIG. 19 illustrates a three dimensional graphical representation of an embodiment to find a value of a feedback parameter of a feedback loop that produces an extremum of a combined normalized performance characteristic; and

FIG. 20 illustrates a flow diagram of an embodiment of a method of determining a value of a feedback parameter of a feedback loop of a power converter.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems, and modules associated with selecting a feedback parameter (e.g., the P, I and D parameters set in the PID regulator) of a power converter.

A process will be described herein with respect to exemplary embodiments in a specific context, namely, a system and method of a selecting a feedback parameter for a power converter that can be readily determined and used with a high level of performance in diverse customer applications. While the principles will be described in the environment of a power converter, any environment such as a motor controller or power amplifier that may benefit from such a system and method that enables these functionalities is well within the broad scope of the present disclosure.

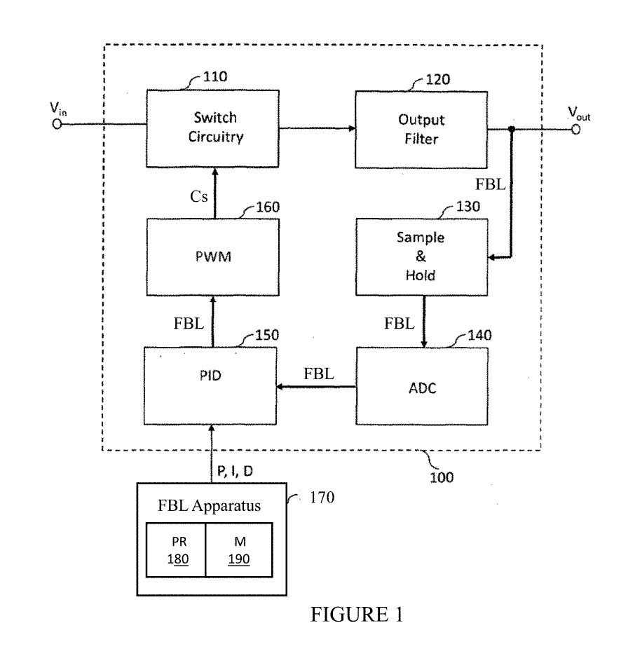

Referring initially to FIG. 1, illustrated is a block diagram of an embodiment of a power converter 100. The power converter 100 includes a switch circuitry 110 including at least one switching device (e.g., a MOSFET) that is controlled at a high frequency (e.g., tens to hundreds of kilohertz (“kHz”)) and with a duty cycle to convert an input voltage Vᵢₙ to an output characteristic (e.g., output voltage Vₒᵤₜ), which is filtered by an output filter 120 (e.g., a first order inductor-capacitor filter). The switch circuitry 110 may include an isolation transformer having a primary winding driven by a primary side circuit, and a secondary winding electromagnetically coupled to the primary winding and arranged to drive a secondary side circuit. The secondary side circuit typically includes a rectifier to produce a direct current (“dc”) output voltage Vₒᵤₜ. One or more switching devices may be provided in one or both of the primary and secondary side circuits. Suitable circuit topologies such as half and full bridge, and forward circuit topologies and other details of the switch circuitry 110, as well as details of the output filter 120, are well-known to those skilled in the art and will therefore not be described herein.

The power converter 100 also includes a controller as part of a feedback loop (generally designated “FBL”) including a sample and hold circuit 130, an analog-to-digital converter (“ADC”) 140, a PID regulator 150 and a pulse-width modulator (“PWM”) 160. The controller regulates the output voltage Vₒᵤₜ in accordance with a control law that is characterized by one or more feedback parameters. The sample and hold circuit 130 samples the output voltage Vₒᵤₜ or a signal indicative thereof (e.g., at intervals of 1 to 10 microseconds) and temporarily stores the sampled values in a buffer. The ADC 140 digitizes the stored sample values The PID regulator 150 regulates the duty cycle (or the switching frequency) of the switching devices to control the output voltage Vₒᵤₜ based on the sample values from the ADC 140 and in accordance with a control law that is characterized by the values of the P, I and D feedback parameters set in the PID regulator 150. Of course, other control laws that define using a different set of one or more feedback parameters may be used to advantage. The PID regulator 150 generates control signals for the PWM 160, which provides control signals Cs to manage a duty cycle for the switching devices or the switch circuitry 110.

In the illustrated embodiment, an apparatus (a feedback loop (“FBL”) apparatus) 170 is coupled to the PID regulator 150, and is provided to determine values of feedback parameters for tuning (e.g., and/or selecting) a feedback parameter for the feedback loop of the power converter 100. The apparatus 170 (e.g., a personal computer) may include a processor (“PR”) 180 and memory (“M”) 190 to perform its function. The processor 180 may be embodied as any type of processor and associated circuitry configured to perform one or more of the functions described herein. For example, the processor 180 may be embodied as or otherwise include a single or multi-core processor, an application specific integrated circuit, a collection of logic devices, or other circuits. The memory 190 may be embodied as read-only memory devices and/or random access memory devices. For example, the memory 190 may be embodied as or otherwise include dynamic random access memory devices (“DRAM”), synchronous dynamic random access memory devices (“SDRAM”), double-data rate dynamic random access memory devices (“DDR SDRAM”), and/or other volatile or non-volatile memory devices. The memory 190 may have stored therein programs including a plurality of instructions or computer program code for execution by the processor 180 to control particular functions of the power converter as discussed in more detail below.

The apparatus may communicate with the power converter 100 through, without limitation, a PMBus protocol if the power converter 100 includes a digital PMBus interface. In an embodiment, the apparatus 170 determines a value of a feedback parameter of a feedback loop FBL of a power converter 100 and includes a processor 180 and a memory (190) including computer program code. The processor 180, the memory 190, and the computer program code are collectively operable to shift an open-loop performance characteristic (e.g., a phase margin) and a closed-loop performance characteristic (e.g., peak gain) of the feedback loop FBL to be greater than or equal to respective constants (e.g., zero). The processor 180, the memory 190, and the computer program code are collectively operable to normalize the open-loop performance characteristic and the closed-loop performance characteristic of the feedback loop FBL to a common scale to provide a normalized open-loop performance characteristic and a normalized closed-loop performance characteristic. The normalization may include raising the open-loop performance characteristic and the closed-loop performance characteristic to a power such as a non-integer power.

The processor 180, the memory 190, and the computer program code are collectively operable to combine the normalized open-loop performance characteristic with the normalized closed-loop performance characteristic to provide a combined normalized performance characteristic. The combing of the normalized open-loop performance characteristic with the normalized closed-loop performance characteristic may include adding the normalized open-loop performance characteristic and the normalized closed-loop performance characteristic. The processor 180, the memory 190, and the computer program code are collectively operable to find a value of the feedback parameter that produces an extremum of the combined normalized performance characteristic. The apparatus 170, for instance, can tune one or more of the values of the P, I and D parameters of the PID regulator 150 (or a different set of feedback parameters, such as the coefficients for a second-order section, or its zeros, and a gain G) of the feedback loop FBL of the power converter 100.

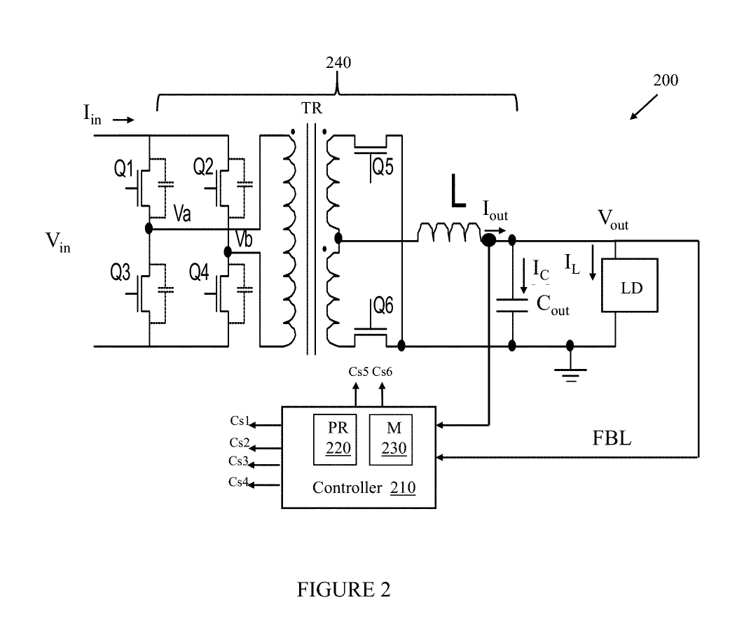

Turning now to FIG. 2, illustrated is a schematic diagram of another embodiment of a power converter 200. A power train 240 of the power converter receives an input current Iᵢₙ and an input voltage Vᵢₙ and includes first and second high-side switching devices Q1, Q2, and first and second low-side switching devices Q3, Q4 arranged in a full bridge configuration and including parasitic capacitances (illustrated with dotted lines as parallel capacitances). The first high-side switching device Q1 is coupled in series at a first circuit node Va with the first low-side switching device Q3. The second high-side switching device Q2 is coupled in series at a second circuit node Vb with the second low-side switching device Q4. The first and second circuit nodes Va, Vb are coupled to opposite ends of a primary winding of a transformer TR. A secondary winding of the transformer TR is coupled to a synchronous rectifier formed by a third low-side switching device Q5 (including a parasitic capacitance, not shown) coupled to a fourth low-side switching device Q6 (including a parasitic capacitance, not shown). A center tap of the secondary winding of the transformer TR is coupled to an output filter including output inductor L and output capacitor Cₒᵤₜ that filters an output voltage Vₒᵤₜ provided to a load (designated “LD”). An output current Iₒᵤₜ is split between the output capacitor Cₒᵤₜ (receiving a capacitor current I_{c}) and the load LD (receiving a load current I_{L}).

The first and second high-side switching devices Q1, Q2, and the first and second low-side switching devices Q3, Q4 are controlled to provide a high frequency ac voltage to the primary winding of the transformer TR. The high frequency ac voltage is induced across to the secondary winding of the transformer TR and the third and fourth low-side switching devices Q5, Q6 are controlled to provide a rectified dc voltage. The rectified dc voltage is then filtered by the output filter, which provides the output voltage Vₒᵤₜ to the load LD. While the switching devices are illustrated as MOSFETs, it should be understood that any semiconductor switch technology can be used as the application dictates. Also, while the power train includes a full bridge configuration and synchronous rectifier, other topologies and rectification techniques may be employed to advantage.

A controller 210 including a processor (“PR”) 220 and memory (“M”) 230 receives the output current Iₒᵤₜ and/or the output voltage Vₒᵤₜ and generates control signals Cs1, Cs2, Cs3, Cs4 for the first and second high-side switching devices Q1, Q2, and first and second low-side switching devices Q3, Q4 to regulate the output voltage Vₒᵤₜ (an output characteristic of the power converter). The controller 210 also generates control signals Cs5, Cs6 for the synchronous rectifier formed by the third and fourth low-side switching devices Q5, Q6.

The processor 220 may be embodied as any type of processor and associated circuitry configured to perform one or more of the functions described herein. For example, the processor 220 may be embodied as or otherwise include a single or multi-core processor, an application specific integrated circuit, a collection of logic devices, or other circuits. The memory 230 may be embodied as read-only memory devices and/or random access memory devices. For example, the memory 230 may be embodied as or otherwise include dynamic random access memory devices (“DRAM”), synchronous dynamic random access memory devices (“SDRAM”), double-data rate dynamic random access memory devices (“DDR SDRAM”), and/or other volatile or non-volatile memory devices. The memory 230 may have stored therein programs including a plurality of instructions or computer program code for execution by the processor 220 to control particular functions of the power converter as discussed in more detail below.

Thus, in the illustrated embodiment, the power converter 200 includes a feedback loop FBL and a power train 240 configured to convert the input voltage Vᵢₙ to the output voltage Vₒᵤₜ. A controller 210 of the power converter is configured to shift an open-loop performance characteristic (e.g., a phase margin) and a closed-loop performance characteristic (e.g., peak gain) of the feedback loop FBL to be greater than or equal to respective constants such as zero. The controller 210 is also configured to normalize the open-loop performance characteristic and the closed-loop performance characteristic of the feedback loop FBL to a common scale to provide a normalized open-loop performance characteristic and a normalized closed-loop performance characteristic. The normalization may include raising the open-loop performance characteristic and the closed-loop performance characteristic to a power such as a non-integer power.

The controller 210 is also configured to combine the normalized open-loop performance characteristic with the normalized closed-loop performance characteristic to provide a combined normalized performance characteristic. The combing of the normalized open-loop performance characteristic with the normalized closed-loop performance characteristic may include adding the normalized open-loop performance characteristic and the normalized closed-loop performance characteristic. The controller 210 is also configured to find a value of the feedback parameter that produces an extremum of the combined normalized performance characteristic.

The aforementioned operation of the controller 210 may be implemented as hardware (embodied in one or more chips including an integrated circuit such as an application specific integrated circuit), or may be implemented as software or firmware for execution by the processor 220. In particular, in the case of firmware or software, the exemplary embodiment can be provided as a computer program product including a computer readable storage medium embodying computer program code (i.e., software or firmware) thereon resident in the memory 230 and for execution by the processor 210.

In general, finding optimal parameters for a feedback loop of a power converter can be a challenging task. Often the best open-loop performance characteristics lead to suboptimal closed-loop performance characteristics, especially when digital elements are employed in the feedback loop. In order to use an efficient technique, it is suggested to combine the open- and closed-loop performance characteristics. This is challenging since the nature of the performance characteristics is very different. A phase margin may be exceeded by 10 to 30 degrees, while the peak-gain may be exceeded with only 0.5 to 1 decibels (“dB”). Thus, the problem solved herein is to how to simultaneously address different open- and closed-loop performance characteristics that affect, for example, stability requirements in the feedback loop of the power converter.

One performance criterion relates to the sign of the open- and closed-loop performance characteristics. As examples, gain margin and phase margin (open-loop performance characteristics) should be positive and larger than a respective constraint, whereas feedback gain at Nyquist (a closed-loop performance characteristic) should be negative and the performance is improved as the value thereof gets more negative. Peak gain (a closed-loop performance characteristic) should be minimized and can be optimum at a value of 0 dB.

Another performance consideration relates to the ranges of values of the open- and closed-loop performance characteristics. Gain margin is generally expressed in decibels and can vary from −12 to +40 dB, which is a very wide range when expressed as a linear characteristic. As an example, in order to determine ranges of performance characteristics for a power train of a power converter, 120,000 different simulations of feedback parameters of an example feedback loop can be performed.

A first stage of the process introduced herein is a normalization process for the performance characteristics of the feedback loop that can be briefly described as follows: The signs of the performance characteristics are changed as needed so that an increasing value means increased feedback loop stability. Next, given performance criteria such as requirement levels are subtracted from the performance characteristics to produce positive values corresponding to fulfilled criteria. Then the values of an independent (i.e., x-axis) feedback parameter are shifted so that the previously modified performance characteristics each achieve a value of about zero at the same x-value. Coefficients (e.g., multiplicative coefficients) are determined for each performance characteristic to produce modified performance characteristic values so that they all fall in a comparable range of values. Then all the modified performance characteristics are weighted and combined (e.g., summed) to form a combined normalized performance characteristic (e.g., a common optimization variable). The combined normalized performance characteristic is examined to ascertain an extremum (or near extremum) and, consequently, find a corresponding value of a feedback parameter of a feedback loop of a power converter that produced an extremum (or near extremum).

Thus, a procedure is set forth for designing a feedback loop and selecting values for feedback parameters thereof. A sign of a performance characteristic is changed if necessary so that an increased value indicates an increased stability or performance of the performance characteristic. Criteria such as requirement levels are subtracted from the performance characteristics that may have been modified with the sign change to produce a positive value corresponding to a fulfilled requirement. The performance characteristics are then scaled (e.g., using a table of coefficients). The modified performance characteristics are then weighted and combined to form a combined normalized performance characteristic (e.g., a common optimization variable) dependent on a feedback parameter. An optimization algorithm is then run to find and/or select a value for the feedback parameter.

The method of combining open-loop performance characteristics (phase margin and gain margin) with closed-loop performance characteristics (e.g., a gain at Nyquist frequency and a peak gain) includes forming a goal function that has a clear peak value. The peak value can be optimized using an optimization technique such as the Nelder-Mead or steepest descent methods as described in U.S. Patent Application Publication No. 2015/0303804 by Mellteg, et al., entitled “Switched Mode Power Supply Compensation Loop,” published Oct. 22, 2015, which is incorporated herein by reference. The use of a single goal function as opposed to four different goal functions that have very different characteristics may simplify the process and avoid local optima that can present difficulties during optimization. It is noted that an extremum of an optimization process as introduced herein may include values that are near the extremum, or a high and acceptably practical value of a particular performance characteristic and/or feedback parameter.

Manually finding appropriate values for feedback parameters is difficult since dissimilar feedback parameters affect goal properties differently. Table 1 below shows the difference between a manually created configuration and a configuration performed by the optimization process introduced herein. A filter used is a pi-filter with one 470 microFarad (“μF”)/10 milliohm (“mΩ”) and five 100 μF/10 mΩ capacitors located close to a power converter module and one 470 μF/10 mΩ and five 100 μF/10 mΩ capacitors located close to a load. The inductance of an inductor of the filter is 10 nanoHenries (“nH”).

TABLE 1

| | | | Phase | Gain | Gain at | Peak |
|---|---|---|---|---|---|---|
| | Gain | Residual | Margin | Margin | Nyquist | Gain |
| Manual | 312 | 104 | 69 degrees | 16 dB | −29 dB | 0.75 |
| Optimized | 170 | 123 | 101 degrees | 21 dB | −34 dB | 0 |

While the manually created configuration illustrated in Table 1 meets all criteria, the optimized configuration provides a significant improvement. Investigating the entire range of the values of the feedback parameters of the feedback loop can be a very time consuming task. An exhaustive search can sometimes take hours (e.g., 10 hours) compared to the optimization process introduced herein that normally finishes in minutes (e.g., two minutes).

A number of simulations of power converter systems have been performed. The Q-value (“quality value,” an indicator of damping) of a second-order system that describes the power train of the power converter can be represented by the equation Q=1/(2·d), where d is its damping. A low value of damping produces a high Q-value that can be characterized as prone to ringing.

The following feedback loop criteria have been used in the example illustrated in Table 2.

TABLE 2

| Phase margin | ≧60 degrees |
|---|---|
| Gain margin | ≧10 dB |
| Gain at Nyquist | ≦10 dB |
| Peak gain | ≦1 |

In an embodiment, a sampled-data single-cycle charge regulator transfer function for the power converter expressed in the z-transform domain can be represented by the function of Gc(z):

$$Gc ( z ) := \frac{Ka + Ki - ( Ka + Ka \cdot β ) \cdot {z}^{- 1} + Ka \cdot β \cdot {z}^{- 2}}{( 1 - {z}^{- 1} )} .$$

A single-cycle charge regulator is described by Chris Young in U.S. Pat. No. 8,575,910, entitled “Single-Cycle Charge Regulator for Digital Control,” dated Nov. 5, 2013, which is incorporated herein by reference. A second-order PID feedback gain for the power converter, also as a function of z, can be expressed as:

$$PID ( z ) = \frac{TapA + TapB \cdot {z}^{- 1} + TapC \cdot {z}^{- 2}}{( 1 - {z}^{- 1} )} .$$

In the equations above z⁻¹ represents a delay of one sampling cycle, and

TapA=Ka+Ki,

TapB=Ka(1+β), and

TapC=Ka(β).

In the equations above Ka represents a selectable gain that will be shown in the FIGUREs described below, and Ki represents a fixed integral gain value. The parameter β represents a “residual value” that will be shown in the FIGUREs. The signals TapA, TapB, and TapC represent outputs of a two-stage tapped delay line formed with two sampling delays z⁻¹.

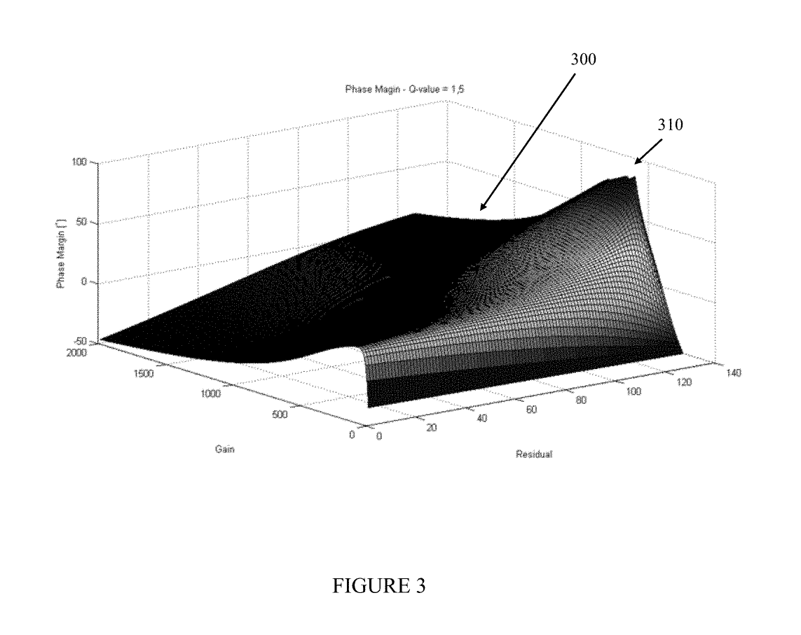

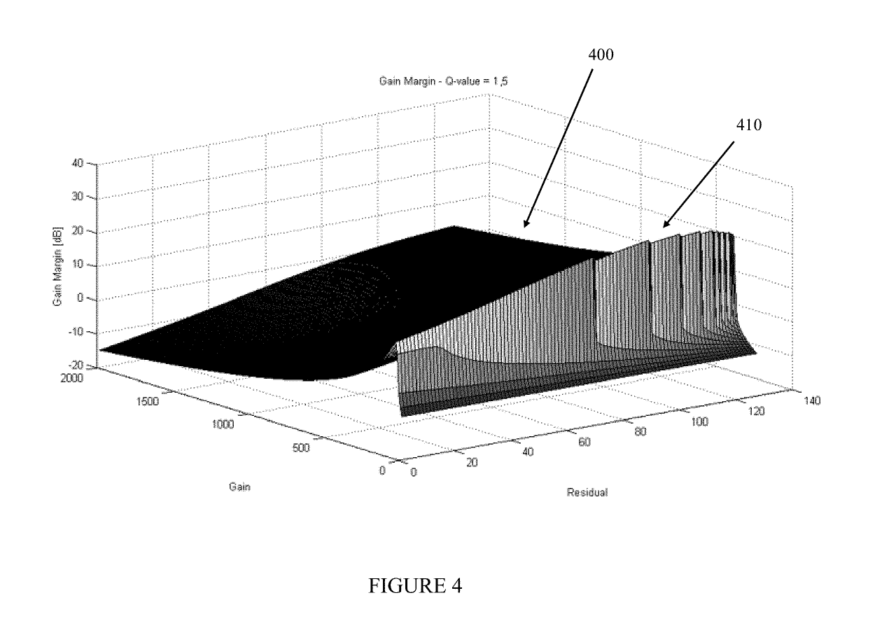

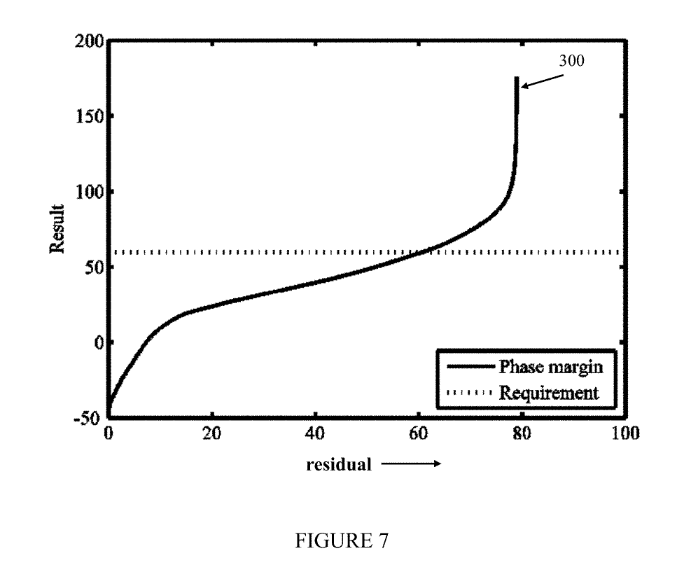

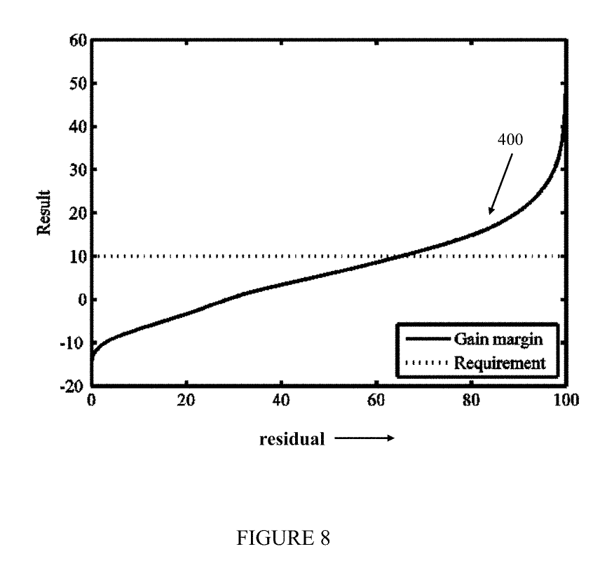

Turning now to FIGS. 3 to 10, illustrated are graphical representations of embodiments of open- and closed-loop performance characteristics for a feedback parameter. A phase margin 300 and gain margin 400 (open-loop performance characteristics) are illustrated in three dimensional graphical representations of FIGS. 3 and 4, respectively, with gain values plotted on a horizontal axis extending to the left and residual values plotted on a horizontal axis extending to the right. The phase margin 300 indicates a peak phase margin value 310 and the gain margin 400 indicates a peak gain margin value 410. The phase margin 300 and gain margin 400 are also illustrated in two dimensional graphical representations of FIGS. 7 and 8, respectively, with the respective values plotted on a vertical axis and the residual values plotted on a horizontal axis. The phase margin 300 meets a criterion (e.g., requirement) for the feedback parameter at about a phase margin value of 50 degrees (or higher) at a residual value of 60 (or more). The gain margin 400 meets a criterion (e.g., requirement) for the feedback parameter at about a gain margin value of 10 dB (or higher) at a residual value of 60 (or more). It should be noted that the residual values are sorted by size and provide a relative value verses the gain values as opposed to an absolute value.

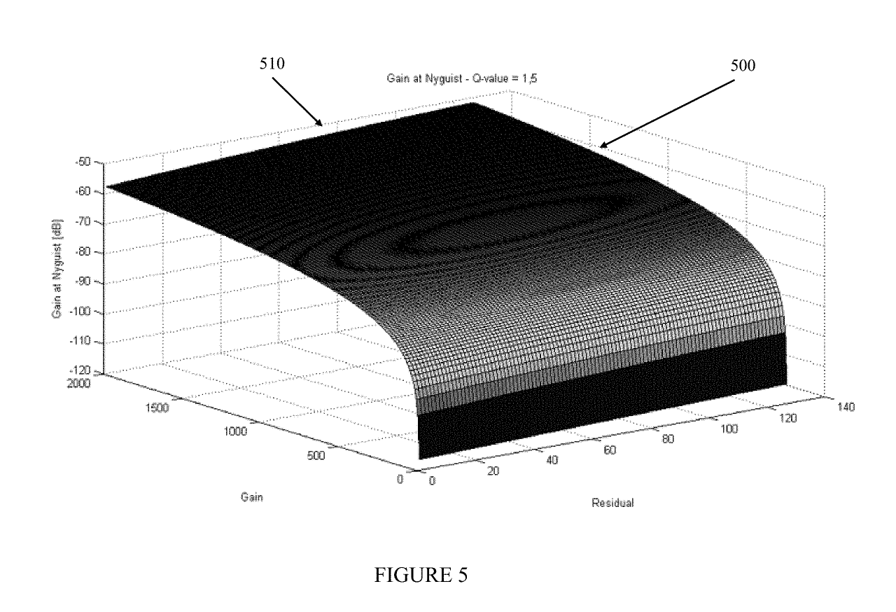

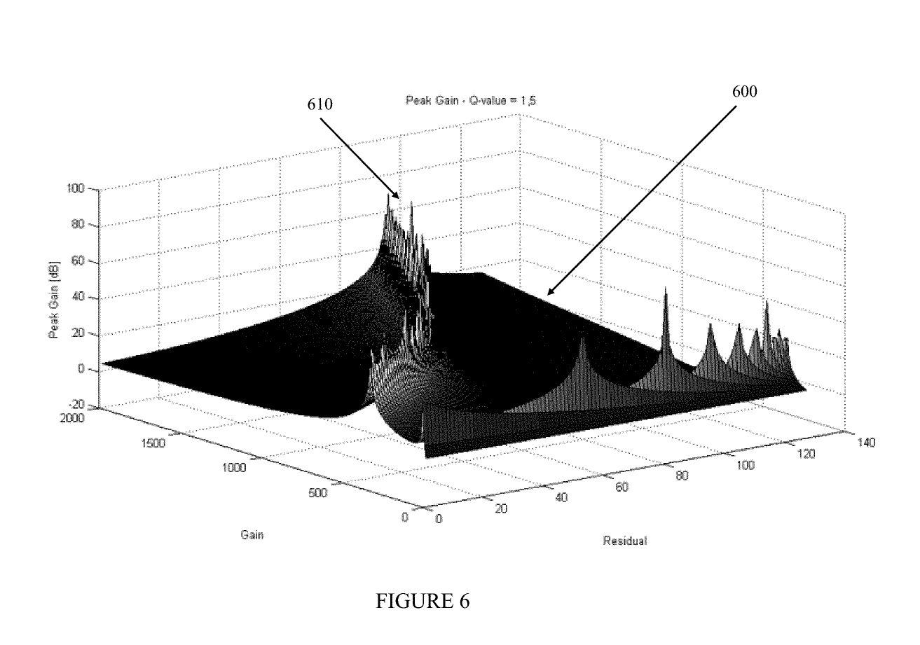

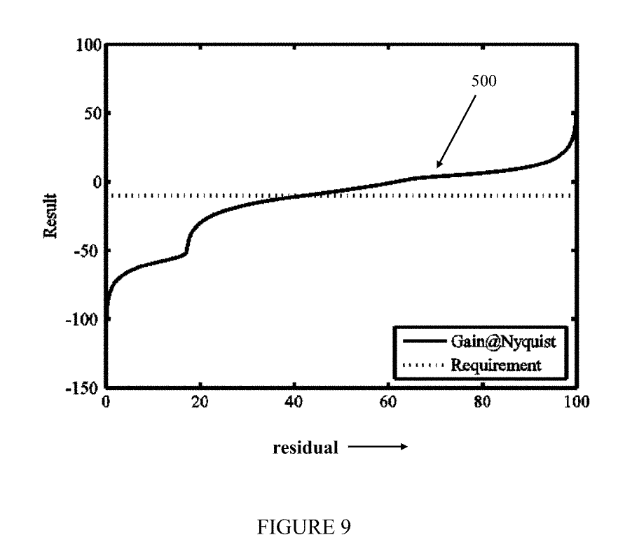

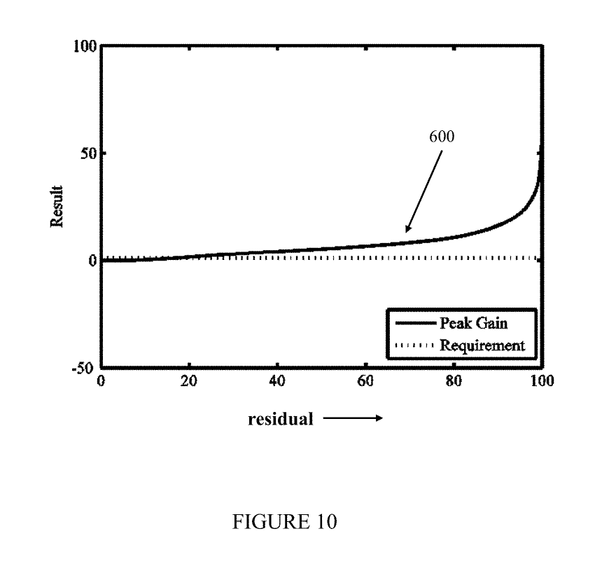

A gain at Nyquist 500 and peak gain 600 (closed-loop performance characteristics) are illustrated in three dimensional graphical representations of FIGS. 5 and 6, respectively, with gain values plotted on a horizontal axis extending to the left and residual values plotted on a horizontal axis extending to the right. The gain at Nyquist 500 indicates a substantially constant peak across many gain at Nyquist values (generally designated 510) and the peak gain 600 has a number of high peak gain values (generally designated 610). The gain at Nyquist 500 and peak gain 600 are also illustrated in two dimensional graphical representations of FIGS. 9 and 10, respectively, with the respective values plotted on a vertical axis and the residual values plotted on a horizontal axis. The gain at Nyquist 500 meets a criterion (e.g., requirement) for the feedback parameter at about a gain at Nyquist value of 0 dB (or higher) at a residual value of 40 (or more). The peak gain 600 meets a criterion (e.g., requirement) for the feedback parameter at about a peak gain value of 1 dB (or higher) at a residual value of 10 (or more).

From the graphical representations, optimizing on phase margin 300 does not lead to an optimized gain margin 400. Moreover, optimizing on only one performance characteristic can in many cases can lead to Error! Reference source not found.configurations where not all criteria are fulfilled or a configuration where one performance characteristic is far above its criterion while others meet their criterion.

The challenges with evaluating the four different performance characteristics for a feedback parameter can be summarized as set forth below. The open-loop performance characteristics should be maximized while the close loop performance characteristics should be minimized. The different performance characteristics often exceed their respective criterion by dissimilar amounts (e.g., phase margin 300 exceeds its criterion at about 50 degrees (residual of 60), while peak gain 600 exceeds its criterion at about 1 dB (residual of 10). The different performance characteristics also miss their criterion by different amounts (e.g., phase margin 300 may miss its criterion by a factor of “x” and the peak gain 600 may miss its criterion by a factor of “2x”). In order to find how the different performance characteristics can be combined, all the values of the different performance characteristics can be evaluated.

In order to compare the performance characteristics, the performance characteristics are adjusted so that all criteria are characterized with the performance characteristics value being greater than or equal to respective constants such as zero. This is achieved for this example by the following offset substitutions and sign inversions:
PM←PM-PMᵣ,
GM←GM-GMᵣ,
GN←GNᵣ-GN, and
PG←PGᵣ-PG,
   where:

PM=Phase Margin, PMᵣ=Phase Margin Requirement (60 degrees),

GM=Gain Margin, GMᵣ=Gain Margin Requirement (10 dB),

GN=Gain At Nyquist, GNᵣ=Gain At Nyquist Requirement (−10 dB), and

PG=Peak Gain, PGᵣ=Peak Gain Requirement (1 dB).

The performance characteristics PMᵣ, GMᵣ, GNᵣ, and PGᵣ are known constants determined by design requirements.

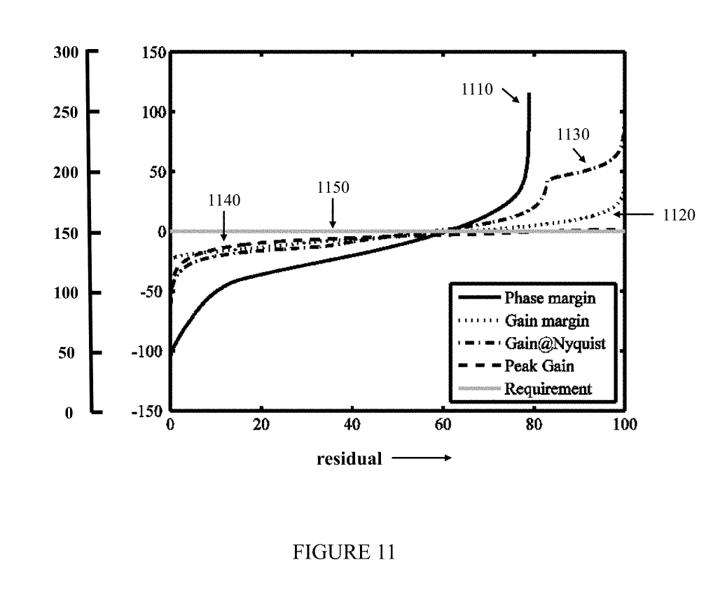

Turning now to FIGS. 11 to 13, illustrated are two dimensional graphical representations of an embodiment of open- and closed-loop performance characteristics for a feedback parameter with respective values plotted on a vertical axis and residual values plotted on a horizontal axis. Beginning with FIG. 11, the open-loop performance characteristics include a phase margin 1110 and a gain margin 1120. The close-loop performance characteristics include a gain at Nyquist 1130 and a peak gain 1140. A criterion (e.g., requirement) 1150 for the feedback parameter is also illustrated in FIG. 11. As a result of substitutions and sign inversions, the open- and closed-loop performance characteristics are scaled to positive values as depicted by the second non-zero scale from 0 to 300.

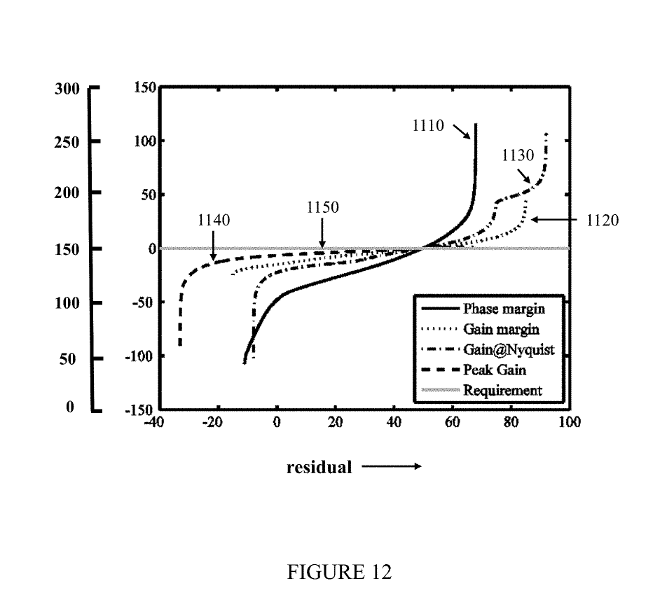

As illustrated in FIG. 12, the residual values are adjusted to cause the graphical representations of the phase margin 1110, the gain margin 1120, the gain at Nyquist 1130 and the peak gain 1140 to meet the respective criterion (e.g., requirements) at the same residual value (at about 50). The adjustment will make it easier to analyze how the different derived values differ. In order to further facilitate comparison of the results illustrated in FIG. 12,Error! Reference source not found. the following scaled exponential equation is applied to modify each property to normalize the results:

$${v}_{m} = \{ \begin{matrix}- {α}_{1} \cdot {\vert v \vert}^{{α}_{2}} , v < 0 \\ {β}_{1} \cdot {v}^{{β}_{2}} , v \geq 0\end{matrix} .$$

The variable vₘ represents a normalized phase margin, gain margin, gain at Nyquist, or peak gain, and the variables α₁, α₂, β₁, and β₂ are constants that allow the different criteria or requirement types to be compared with a generally common scale. The resulting scaled variable vₘ is the normalized value of v. In an embodiment, the variable v is raised to an exponent power that may not be an integer exponent.

With the graph in FIG. 12 as a visual aid, the constants α and β are determined to the following values for this example as illustrated below in Table 3.

TABLE 3

| | α₁ | α₂ | β₁ | β₂ |
|---|---|---|---|---|
| Phase margin | ⅙ | 1 | 1/7 | 1 |
| Gain margin | ½ | 1 | ⅓ | 1 |
| Gain at Nyquist | 1 | ⅔ | 1 | ⅔ |
| Peak gain | 1 | ⅔ | 16 | 2 |

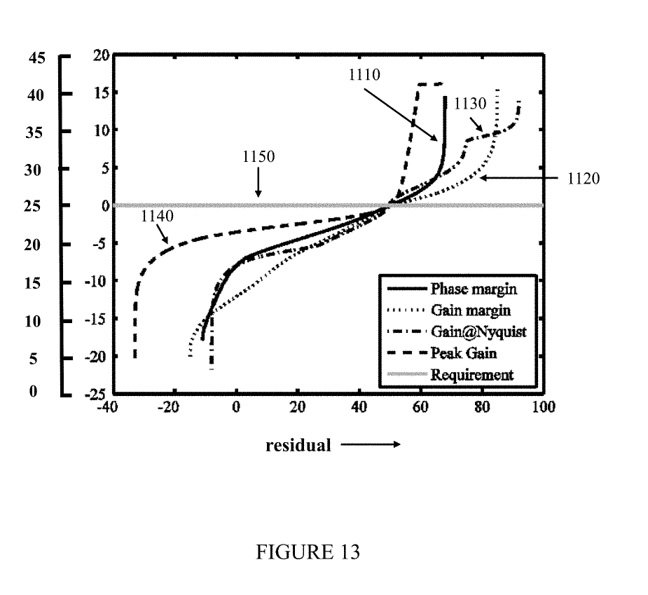

FIG. 13 illustrates the open- and closed-loop performance characteristics of FIG. 12 after applying the normalization equations employing the constants α₁, α₂, β₁ and β₂ shown in Table 3. It should be noted that FIGS. 12 and 13 also include a non-zero scale for the values of the respective open- and closed-loop performance characteristics.

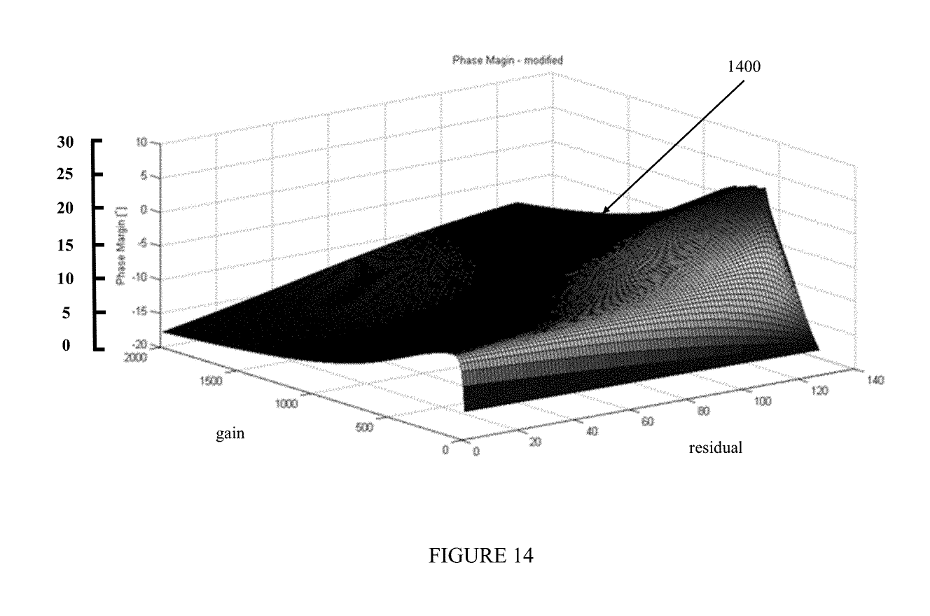

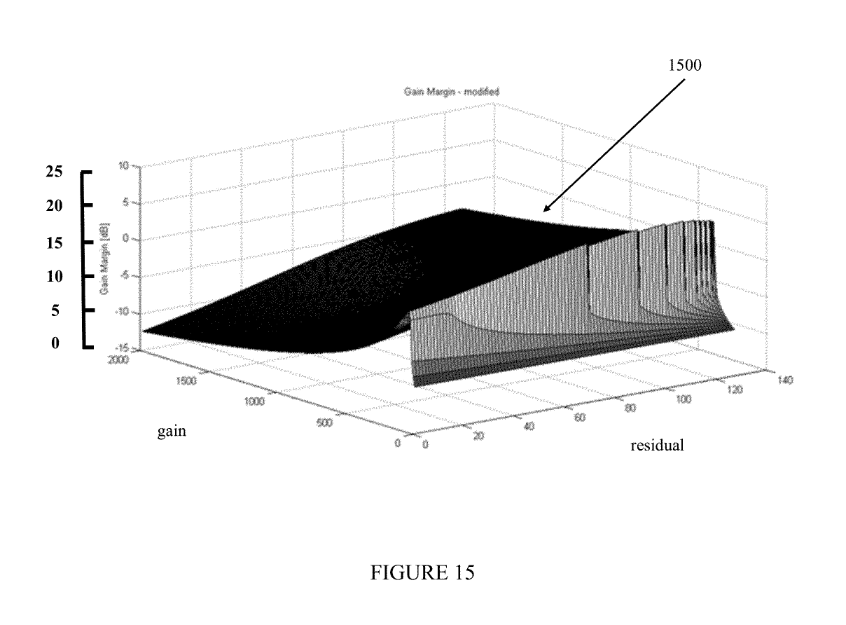

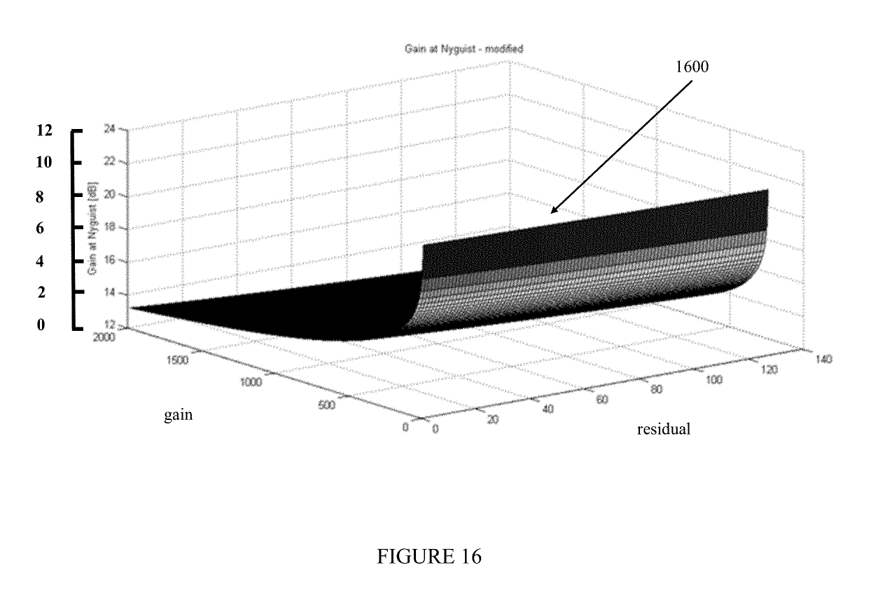

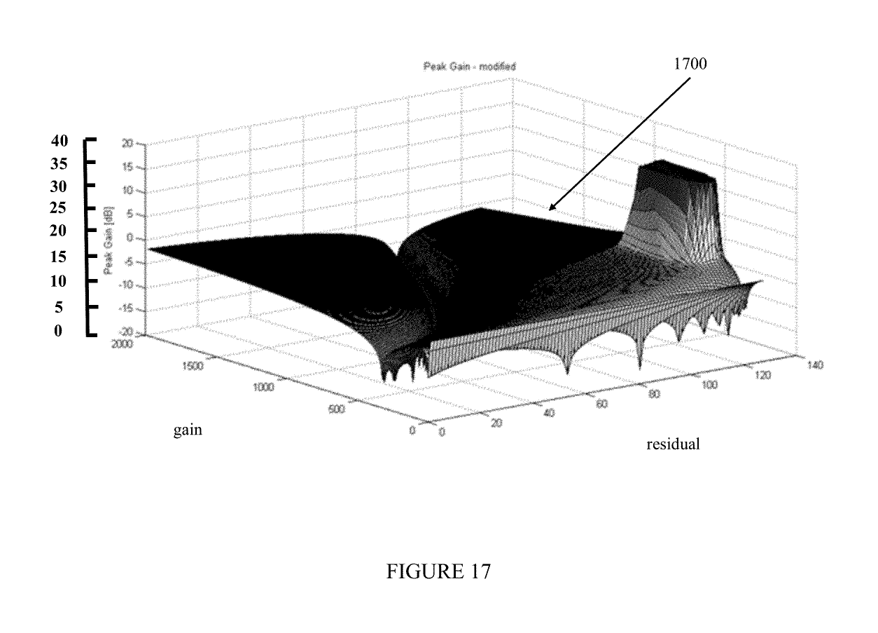

Turning now to FIGS. 14 to 18, illustrated are three dimensional graphical representations of an embodiment of open- and closed-loop performance characteristics for a feedback parameter with gain values plotted on a horizontal axis extending to the left and residual values plotted on a horizontal axis extending to the right. Once values of the phase margin 1400 (see FIG. 14), the gain margin 1500 (see FIG. 15), the gain at Nyquist 1600 (see FIG. 16) and the peak gain 1700 (see FIG. 17) are scaled, adjusted and normalized, the values are comparable. FIGS. 14 to 17 also illustrate a non-zero scale for the values of the respective open- and closed-loop performance characteristics. Since all of the open- and closed-loop performance characteristics are now in the same general range of numerical values, their respect criteria (e.g., requirements) are all fulfilled when each value is greater than or equal to zero.

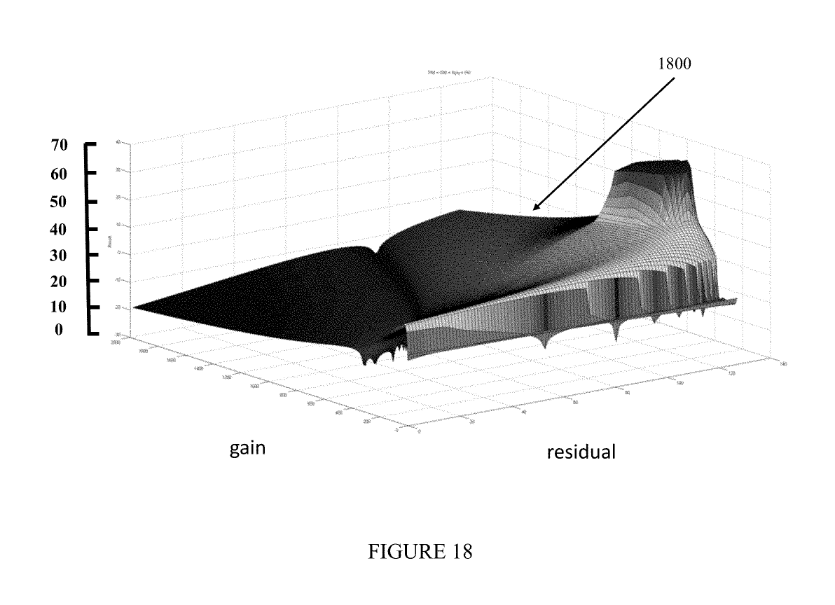

FIG. 18 illustrates a three dimensional graphical representation of combining the open- and closed-loop performance characteristics to provide a combined normalized performance characteristic 1800. FIG. 18 also illustrates a non-zero scale for the values of the combined normalized performance characteristic 1800. It is contemplated within the broad scope of the present disclosure that the normalized open- and closed-loop performance characteristics may be combined via, without limitation, an additive or a multiplicative combining.

This leads to a continuous function with a clear maximum value that is in the range where all property criteria or requirements are fulfilled. The maximum value of this function can be obtained by using, e.g., the Nelder-Mead optimization method. (See, e.g., U.S. Patent Application Publication No. 2015/0303804 by Mellteg, et al., cited above, and a paper by J. A. Nelder and R. Mead, entitled “A Simplex Method for Function Minimization,” published in the Computer Journal, Vol. 7, Issue 4, pages 308-313 (Oxford Journals, 1965), which are incorporated herein by reference.) Other optimization algorithms (such as steepest descent, the Broyden-Fletcher-Goldfarb-Shanno (BFGS) hill-climbing algorithm, etc.) can be used, but the modified Nelder-Mead method has been shown to be quite efficient for finding an extremum. A feedback parameter of a feedback loop can be obtained by finding an extremum of the combined normalized performance characteristic 1800. The feedback parameters provide the maximum or otherwise highly desirable value for robustness. In order to increase the performance of the feedback loop, a step-wise search may be performed over the area that has fulfilled the criteria for each of the feedback parameter.

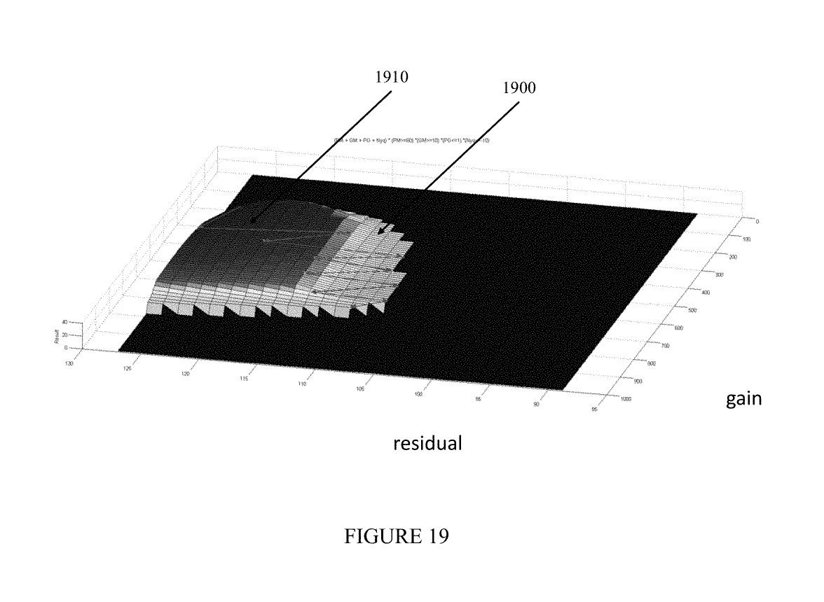

Turning now to FIG. 19 illustrated is a three dimensional graphical representation of an embodiment to find a value of a feedback parameter of a feedback loop that produces an extremum of a combined normalized performance characteristic 1900. The process includes repeatedly, altering search terms in small steps for the feedback parameter until an extremum, practical value of an extremum, or approximation goal from the combined normalized performance characteristic 1900 is reached. The values obtained by the optimization process described above are an appropriate starting point for finding values for the feedback parameters of the feedback path. Finding optimum values are done by repeatedly, in small steps, increasing a first value followed by altering a second value until a limit is reached where the criteria or requirements no longer are fulfilled. The procedure is marked as lines 1910 in FIG. 19.

In an embodiment, the search/optimization steps include increasing a first search value and slightly decreasing a second search value. In a following step, the second value is increased and the first value is slightly decreased. The reason for this is to prevent the path from getting stuck in a corner that is not the optimum solution. Any of the examined parameter value pairs on the way from the maximum robust to the optimized can be used as partly optimized if one does not wish to be close to the limit of being unstable. An example of pseudocode that performs the method as described herein is provided below in Tables 4 and 5. Table 4 provides and describes constants used in the pseudocode with their typical values. Table 5 provides the pseudocode and a description of portions thereof. The two independent performance characteristics in the pseudocode are dependent on gain and residual.

As illustrated below in Tables 4 and 5, the pseudocode that implements a method as described hereinabove uses the functions getFrequencyDomainProperties and findMin. The getFrequencyDomainProperties function may be a simulation or measurement performed on the system. The findMin function uses the Nelder-Mead method for finding the minimum value of a provided function as described in U.S. Patent Application Publication No. 2015/0303804 by Mellteg, et al. The two independent performance characteristics in the pseudocode are dependent on gain and residual.

TABLE 4

| Name | Description | Typical value |
|---|---|---|
| PMr | Phase Margin Requirement | 60 |
| GMr | Gain Margin Requirement | 10 |
| GNr | Gain at Nyquist Requirement | −10 |
| PGr | Peak Gain Requirement | 1 |
| a1_pm | Phase Margin α₁ | ⅙ |
| a2_pm | Phase Margin α₂ | 1 |
| b1_pm | Phase Margin β₁ | 1/7 |
| b2_pm | Phase Margin β₂ | 1 |
| b2_pm | Phase Margin β₂ | 1 |
| a1_gm | Gain Margin α₁ | ½ |
| a2_gm | Gain Margin α₂ | 1 |
| b1_gm | Gain Margin β₁ | ⅓ |
| b2_gm | Gain Margin β₂ | 1 |
| a1_gn | Gain at Nyquist α₁ | 1 |
| a2_gn | Gain at Nyquist α₂ | ⅔ |
| b1_gn | Gain at Nyquist β₁ | 1 |
| b2_gn | Gain at Nyquist β₂ | ⅔ |
| a1_pg | Peak Gain α₁ | 1 |
| a2_pg | Peak Gain α₂ | ⅔ |
| b1_pg | Peak Gain β₁ | 16 |
| b2_pg | Peak Gain β₂ | 2 |
| Dg | Delta Gain | 10 |
| Dr | Delta Residual | 1 |

TABLE 5

| Pseudocode Function | Code Description |
|---|---|
| function normalizeValue(x, a1, a2, b1, b2) { | The function normalizeValue |
| if v < 0 | implements the normalization |
| return −a1*\|v\|\hat{ }a2 | equations: |
| else return b1*v\hat{ }b2 } | ${v}_{m} = \{ \begin{matrix}- {α}_{1} \cdot \vert v {\vert}^{{α}_{2}} , v < 0 \\ {β}_{1} \cdot {v}^{{β}_{2}} , v \geq 0\end{matrix}$ |
| function requirementsGoalFunction(gain, residual) { | The function |
| [GM PM GN PG] = getFrequencyDomainProperties(gain, | requirementsGoalFunction |
| residual); | implements shifted values (and, |
| GMm = GM − GMr | selectivity, sign changes) for |
| PMm = PM − PMr | phase margin, gain margin, gain |
| GNm = GNr − GN | at Myquist, and peak gain |
| PGm = PGr − PG | dependent on known |
| GMm = normalizeValue(GMm, a1_gm, a2_gm, b1_gm, | requirement values for each so |
| b2_gm) | that each performance |
| PMm = normalizeValue(PMm, a1_pm, a2_pm, b1_pm, | characteristic can be compared |
| b2_pm) | with a value such as a zero |
| GNm = normalizeValue(GNm, a1_gn, a2_gn, b1_gn, b2_gn) | value: |
| PGm = normalizeValue(PGm, a1_pg, a2_pg, b1_pg, b2_pg) | PM ← PM-PMᵣ |
| return −(GMm + PMm + GNm + PGm) | GM ← GM-GMᵣ |
| } | GN ← GNᵣ − GN |
| | PG ← PGᵣ − PG |
| | followed by execution of the |
| | normalization function for each |
| | of phase margin, gain margin, |
| | gain at Nyquist, and peak gain. |
| function meetsRequirements(gain, residual) { | The function |
| [GM PM GN PG] = getFrequencyDomainProperties(gain, | “meetsRequirements” tests that |
| residual); | gain margin is greater than or |
| return GM >= GMr && PM >= PMr && GN <= GNr && PG <= | equal to a reference gain |
| PGr | margin, phase margin is greater |
| } | than or equal to a reference |
| | phase margin, gain at Nyquist is |
| | less than or equal to a reference |
| | gain at Nyquist, and peak gain |
| | is less than or equal to a |
| | reference gain. |
| function optimize() { | The function “optimize” |
| [gain residual] = findMin(@requirementsGoalFunction) | performs a search over gain and |
| print “Robust control loop = ” + gain + “,” + residual | residual values to find optimal |
| gainOld = min_value | values therefor. |
| residualOld = max_value | |
| while gain > gainOld or residual < residualOld { | |
| // Find better gain | |
| Imin = 0 | |
| Imax = 10 | |
| gainOld = gain | |
| residualOld = residual | |
| I = Imax | |
| while Imax >= Imin { | |
| if meetsRequirements(gain + dg*I, residual + dr*I/2) { | |
| gainNew = gain + dg*I | |
| residualNew = residual + dr*I/2 | |
| I = I + 1 | |
| } | |
| else | |
| Imax = I − 1 | |
| I = Imin + floor((Imax − Imin)/2) | |
| } | |
| if gainNew > gain { | |
| gain = gainNew; | |
| residual = residualNew | |
| } | |
| // Find better residual | |
| Imin = 0 | |
| Imax = 10 | |
| gainNew = gain | |
| residualNew = residual | |
| I = Imax | |
| while Imax >= Imin { | |
| if meetsRequirements(gain − dg*I/2, residual − dr*I) { | |
| gainNew = gain − dg*I/2 | |
| residualNew = residual − dr*I | |
| I = I − 1 | |
| } | |
| else | |
| Imax = I + 1 | |
| I = Imin + floor((Imax − Imin)/2) | |
| } | |
| if residualNew < residual { | |
| gain = gainNew; | |
| residual = residualNew | |
| } | |
| } | |
| print “Optimized control loop = ” + gain + “,” + residual | The print function of the |
| | pseudocode identifies the |
| | optimum gain and residual |
| | value found by the function |
| | optimize. |

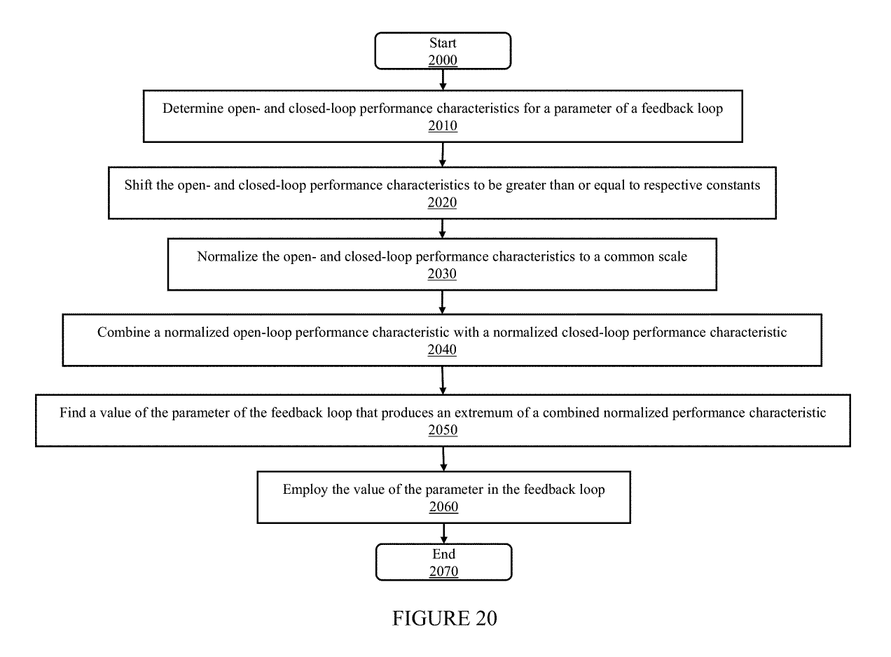

Turning now to FIG. 20, illustrated is a flow diagram of an embodiment of a method of determining a value of a feedback parameter of a feedback loop of a power converter. The method begins at a start step or module 2000. At a step or module 2010, the method includes determining an open-loop performance characteristic (e.g., phase margin) and a closed-loop performance characteristic (e.g., peak gain) of the feedback loop for a feedback parameter employing, for instance, a simulation of the feedback loop. The method, at a step or module 2020, includes shifting the open-loop performance characteristic and a closed-loop performance characteristic to be greater than or equal to respective constants such as zero. The method also includes normalizing the open-loop performance characteristic and the closed-loop performance characteristic to a common scale to provide a normalized open-loop performance characteristic and a normalized closed-loop performance characteristic at a step or module 2030. The normalizing may include raising the open-loop performance characteristic and the closed-loop performance characteristic to a power.

At a step or module 2040, the method includes combining the normalized open-loop performance characteristic with the normalized closed-loop performance characteristic to provide a combined normalized performance characteristic. The combining may include adding the normalized open-loop performance characteristic and the normalized closed-loop performance characteristic. Then, the method includes finding a value of the feedback parameter that produces an extremum of the combined normalized performance characteristic at a step or module 2050. The method, at a step or module 2060, includes employing the value of the feedback parameter in the feedback loop. The method ends at step or module 2070. Of course, the method can be repeated as many iterations as necessary to enhance the feedback loop of the power converter.

The foregoing description of embodiments of the present proposed solution has been presented for the purpose of illustration and description. It is not intended to be exhaustive or to limit the proposed solution to the present form disclosed. Alternations, modifications and variations can be made without departing from the spirit and scope of the present proposed solution.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiment can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A method of determining a value of a feedback parameter of a feedback loop of a power converter, comprising:
normalizing an open-loop performance characteristic and a closed-loop performance characteristic of said feedback loop to a common scale to provide a normalized open-loop performance characteristic and a normalized closed-loop performance characteristic;
combining said normalized open-loop performance characteristic with said normalized closed-loop performance characteristic to provide a combined normalized performance characteristic; and
finding a value of said feedback parameter that produces an extremum of said combined normalized performance characteristic.

2. The method as recited in claim 1 further comprising shifting said open-loop performance characteristic and said closed-loop performance characteristic to be greater than or equal to respective constants.

3. The method as recited in claim 2 wherein said respective constants are zero.

4. The method as recited in claim 1 wherein said normalizing comprises raising said open-loop performance characteristic and said closed-loop performance characteristic to a power.

5. The method as recited in claim 1 wherein said combining comprises adding said normalized open-loop performance characteristic and said normalized closed-loop performance characteristic.

6. An apparatus for determining a value of a feedback parameter of a feedback loop of a power converter, comprising:
a processor; and
a memory including computer program code, wherein said processor, said memory, and said computer program code are collectively operable to:
normalize an open-loop performance characteristic and a closed-loop performance characteristic of said feedback loop to a common scale to provide a normalized open-loop performance characteristic and a normalized closed-loop performance characteristic,
combine said normalized open-loop performance characteristic with said normalized closed-loop performance characteristic to provide a combined normalized performance characteristic, and
find a value of said feedback parameter that produces an extremum of said combined normalized performance characteristic.

7. The apparatus as recited in claim 6 wherein said memory and said computer program code are further configured to, with said processor cause said apparatus to shift said open-loop performance characteristic and said closed-loop performance characteristic to be greater than or equal to respective constants.

8. The apparatus as recited in claim 7 wherein said respective constants are zero.

9. The apparatus as recited in claim 6 wherein said memory and said computer program code are further configured to, with said processor cause said apparatus to normalize by raising said open-loop performance characteristic and said closed-loop performance characteristic to a power.

10. The apparatus as recited in claim 6 wherein said memory and said computer program code are further configured to, with said processor cause said apparatus to combine by adding said normalized open-loop performance characteristic and said normalized closed-loop performance characteristic.

11. A power converter including a feedback loop, comprising:
a power train configured to convert an input voltage to an output voltage; and
a controller configured to:
normalize an open-loop performance characteristic and a closed-loop performance characteristic of said feedback loop to a common scale to provide a normalized open-loop performance characteristic and a normalized closed-loop performance characteristic,
combine said normalized open-loop performance characteristic with said normalized closed-loop performance characteristic to provide a combined normalized performance characteristic, and
find a value of said feedback parameter that produces an extremum of said combined normalized performance characteristic.

12. The power converter as recited in claim 11 wherein said controller is further configured to shift said open-loop performance characteristic and said closed-loop performance characteristic to be greater than or equal to respective constants.

13. The power converter as recited in claim 12 wherein said respective constants are zero.

14. The power converter as recited in claim 11 wherein said controller is further configured to normalize by raising said open-loop performance characteristic and said closed-loop performance characteristic to a power.

15. The power converter as recited in claim 11 wherein said controller is further configured to combine by adding said normalized open-loop performance characteristic and said normalized closed-loop performance characteristic.

16. A computer program product comprising a program code stored in a tangible form in a computer readable medium, operable to cause a controller comprising a processor and a memory to:
normalize an open-loop performance characteristic and a closed-loop performance characteristic of a feedback loop of a power converter to a common scale to provide a normalized open-loop performance characteristic and a normalized closed-loop performance characteristic;
combine said normalized open-loop performance characteristic with said normalized closed-loop performance characteristic to provide a combined normalized performance characteristic; and
find a value of said feedback parameter that produces an extremum of said combined normalized performance characteristic.

17. The computer program product of claim 16 wherein said program code stored in said computer readable medium is operable to cause said controller to shift said open-loop performance characteristic and said closed-loop performance characteristic to be greater than or equal to respective constants.

18. The computer program product as recited in claim 17 wherein said respective constants are zero.

19. The computer program product of claim 16 wherein said program code stored in said computer readable medium is operable to cause said controller to normalize by raising said open-loop performance characteristic and said closed-loop performance characteristic to a power.

20. The computer program product of claim 16 wherein said program code stored in said computer readable medium is operable to cause said controller to combine by adding said normalized open-loop performance characteristic and said normalized closed-loop performance characteristic.
